(19) United States
(12) Patent Application Publication
(10) Pub. No.: US 2022/0281415 A1
(43) Pub. Date: Sep. 8, 2022

(54) Windshield Cleaning Appliance and Cleaner Composition

(71) Applicants: Dennis Willard Davis, Palm Bay, FL (US); James Grant Wallin, Terra Ceia, FL (US)

(72) Inventors: Dennis Willard Davis, Palm Bay, FL (US); James Grant Wallin, Terra Ceia, FL (US)

(21) Appl. No.: 17/751,881

(22) Filed: May 24, 2022

Related U.S. Application Data
(63) Continuation-in-part of application No. 16/872,682, filed on May 12, 2020.
(60) Provisional application No. 63/194,256, filed on May 28, 2021.

(51) Int. Cl. B60S 1/04; C11D 1/62; C11D 11/00; C11D 17/04

(52) U.S. Cl. CPC B60S 1/0433; C11D 1/62; C11D 11/0035; C11D 17/041; B60S 2001/3843

(57) ABSTRACT

Presently disclosed are embodiments of devices for expedient removal of insect and other debris from vehicle surfaces including windshields. A surfactant-based chemical impregnation of porous material is central to various tools used for such cleaning. Embodiments include a wiper attachment, tools for dispensing disposable chemically-impregnated pads, mitts, and wiper fluid formulations. A disposable windshield wiper blade attachment that incorporates chemicals that will expedite insect and other debris removal when attached to the wiper blades and the wiper action is performed. The attachment can take the form of fabric, foam, or other porous enclosure of synthetic or natural material that is impregnated with chemicals that will facilitate rapid removal of the windshield and automobile surface debris.

### CROSS-REFERENCE TO RELATED APPLICATIONS

This application is a continuation-in-part of U.S. patent Ser. No. 16/872,682 filed May 12, 2020 for “Windshield Cleaning Appliance and Cleaner Composition” by Dennis W. Davis and James G. Wallin now abandoned and claims the benefit of U.S. provisional application Patent Application Ser. No. 62/920,738 for “Windshield Cleaning Appliance” filed May 13, 2019 by Dennis W. Davis and James G. Wallin, and U.S. provisional application Patent Application Ser. No. 63/194,256 filed May 28, 2021 for “Windshield Cleaning Appliance and Cleaner Composition” by Dennis W. Davis and James G. Wallin.

### BACKGROUND

Motorized vehicles of all kinds, including cars, trucks, recreational vehicles, heavy equipment vehicles, buses, boats, and private aircraft, are invariably impacted by insects colliding with the vehicle windshield. The resulting insect residue on windshields can be messy and especially difficult to remove if the insect debris has become desiccated.

The windshields, grills, bumpers, and other surfaces of moving vehicles encounter many different species of insects, but larger numbers are associated with particular ones including mayflies of the northern US, midges or small flies (including aquatic midges known as blind mosquitos and no-see-ums) and mosquitoes found throughout the US. Particularly bothersome is the love bug (Plecia nearctica), a species of March fly found in the southeastern United States, especially along the Gulf Coast.

Often, the insect debris is of sufficient volume that the windshield and wiper blades need to be toweled in addition to using wiper motion with dispensed wiper fluid. Quite often, wipers will simply smear the insect debris across the windshield. In the event the wiper fluid is depleted, things are even more difficult. When remote from a gas station there is the inconvenience of the need to locate a source of water for cleaning the windshield. A particular challenge is the removal of desiccated insect debris that adheres tenaciously to vehicle surfaces including glass windshields. Methyl alcohol (the chief ingredient of wiper fluid) alone, often is ineffective in removing desiccated insect and other debris from windshields.

### PRIOR ART

To date, methods to address difficult-to-remove windshield dirt comprise use of windshield wiper fluid, dispensed while operating windshield wipers (this often smears the dirt deposits), and Ice scrapers and squeegees, which usually must be used in concert with paper towels or rags.

U.S. patent application number 2004/0156991 to Brown et al. discloses a dispenser that is attached to or made part of a wiper blade that dispenses hydrophobic or hydrophilic surface treatment material to the windshield for either repelling water or wetting the windshield, respectively. This involves a modification of the actual wiper blade that could accumulate debris.

The product called Scrubberblade (https://gadgetsgo.com/scrubbing-wind-shield-wipers.html) comprises a wiper double blade design that exhibits small protuberances on the blades. Even this improved wiper blade design will have trouble with desiccated debris.

U.S. Pat. No. 6,687,946 discloses a wiper blade attachment with pressurized inflatable scrubbing member. The device is pressurized by windshield wiper fluid and permits seepage of fluid onto the windshield. This is a semi-permanent attachment and is not disposable.

U.S. patent application number 2013/0000802 provides an example of coverings for windshield wiper blades designed to impede ice formation on the blades. Other such covers are for the purpose of preventing ultraviolet light damage to the blade rubber.

It would be advantageous to have a system of appliances and tools based on effective insect debris removal chemistry that can be used to clean external vehicle surfaces of these contaminants. More particularly, an approach that uses windshield wipers for efficient insect debris removal should be sought that a) does not involve modification of the wiper blade, ie. adhoc modification of the existing wiper or replacement with blades of a different design, b) minimizes the user's exposure to the dirt and debris to be removed, and c) is disposable. Additionally, the chemistry used for the aforementioned mechanism would be useful for hand wipes, windshield wiper fluid, and manual tools that dispense this chemistry for insect debris removal from vehicle surfaces.

### SUMMARY OF THE INVENTION

Presently disclosed is a set of embodiments that each exploit chemical means of removing insect debris from vehicle bodies, bumpers and windshields. Chemically-impregnated material is part of various embodiments disclosed. Among the disclosed embodiments are a disposable windshield wiper blade attachment that incorporates chemicals that will expedite insect and other debris removal when attached to the wiper blades and the wiper action is performed. The attachment can take the form of fabric, foam, or other porous enclosure of synthetic or natural material that is impregnated with chemicals that will facilitate rapid removal of the windshield debris. Other embodiments include a handheld tool with pad or roller dispensers of chemically-impregnated porous material. Variants of such tools include a squeegee. Additionally, chemically-impregnated material affixed to hand mitts and formulations of windshield wiper fluid containing chemistries effective for insect debris removal are disclosed.

The following definitions serve to clarify the disclosed and claimed invention:

Surfactants—are compounds that lower the surface tension (or interfacial tension) between two liquids, between a gas and a liquid, or between a liquid and a solid. Surfactants may act as detergents, wetting agents, emulsifiers, foaming agents, or dispersants. Surfactants are usually organic compounds that are amphiphilic, meaning they contain both hydrophobic groups (their tails) and hydrophilic groups. Therefore, a surfactant contains both a water-insoluble (or oil-soluble) component and a water-soluble component. Surfactants will diffuse in water and adsorb at interfaces between air and water or at the interface between oil and water, in the case where water is mixed with oil. The water-insoluble hydrophobic group may extend out of the bulk water phase, into the air or into the oil phase, while the water-soluble head group remains in the water phase.

Quats (quaternary ammonium compounds)—are positively charged polyatomic ions of the structure NR₄⁺ with R being alkyl or aryl groups. The R groups may also be connected.

Polyquaterniums (polyquats)—are a variety of engineered polymer forms which provide multiple quat molecules within a larger molecule.

Fatty acid—is a carboxylic acid with a long aliphatic chain, which is either saturated or unsaturated.

Glyceride—is a fatty acid ester of glycerol.

Impregnated material—refers to porous material that is chemically-impregnated with insect debris cleaning compounds such as surfactants or surfactant polymers.

Microfiber—is synthetic fiber finer than one denier or decitex/thread, having a diameter of less than ten micrometers. The most common types of microfiber are made variously of polyesters; polyamides; and combinations of polyester, polyamide, and polypropylene.

### DESCRIPTION OF THE DRAWINGS

FIG. 1 is a pictorial diagram of a windshield wiper blade assembly and arm.

FIG. 2A is a pictorial diagram of a windshield wiper blade assembly and arm highlighting the angle between the arm and the blade assembly.

FIG. 2B is a pictorial diagram of a windshield cleaning wiper attachment that exhibits clamping tension and a slot for installation and removal.

FIG. 2C is a pictorial diagram of the windshield cleaning wiper attachment of FIG. 2B installed on a windshield wiper blade assembly.

FIG. 3A is a pictorial diagram of a windshield cleaning wiper attachment that is attached to the wiper assembly by tabs.

FIG. 3B is a pictorial diagram of a windshield cleaning wiper attachment that is attached to the wiper assembly by affixing strips.

FIG. 4A is a pictorial diagram of a windshield cleaning wiper attachment that comprises a bag geometry enclosing the windshield wiper blade assembly and a portion of the arm.

FIG. 4B is a pictorial diagram of a windshield cleaning wiper attachment that comprises a bag geometry enclosing the windshield wiper blade assembly the exhibits a pleated region in the area of the arm attachment to the wiper blade assembly.

FIG. 4C is a pictorial diagram of a windshield cleaning wiper attachment that comprises a dual bag geometry with one bag end overlapping and closing upon the other bag end.

FIG. 5A is a pictorial diagram of a windshield wiper blade assembly and arm characteristic of trucks and other vehicles in which the angle between the arm and the blade assembly remains relatively constant.

FIG. 5B is a pictorial diagram of a windshield cleaning wiper attachment adapted to the windshield wiper blade assembly and arm of FIG. 5A comprising and enclosure of both the windshield wiper blade assembly and a portion of the arm.

FIG. 6A is a pictorial diagram of a cleaning tool that has a roller dispenser of chemically-impregnated cleaning material.

FIG. 6B is a pictorial diagram of a roller locking mechanism for the tool of FIG. 6A.

FIG. 7 is a pictorial diagram of a tool having the dispenser of FIG. 6A, but including a squeegee.

FIG. 8 is a pictorial diagram of a cleaning tool that exhibits a dispenser of peelable cleaning wipes.

FIG. 9 is a pictorial diagram of a cleaning tool the exhibits a roller dispenser for peelable cleaning wipes.

Figure 10A is a pictorial diagram of a shaped mitt with an attached chemically-impregnated material for cleaning.

FIG. 10B is a pictorial diagram of a relatively unshaped mitt with an attached chemically-impregnated material for cleaning.

### DETAILED DESCRIPTION OF THE INVENTION

A disposable sleeve or enclosure for removable application to windshield wipers that contains chemicals that expedite the removal of dried material from windshields such as insect debris, especially dried insect debris is disclosed below.

Debris removal chemistry

The central objective of a cleaning compound in the context of the present invention is to overcome desiccation because to remove the insect residue, forces have to be brought to bear at the interface between the insect debris and the automobile surface. Application of water and cloth friction will do nothing because the dry insect is, effectively, an extension of the automobile. While it's easy to remove a large dried volume of insect residue by applying leverage to peel it off, there are no peeling forces in the case of a thin desiccated material layer. However, once the insect debris is swollen, the wiping of a cloth applies forces adequate for removal; a few molecules of water between two surfaces drastically decreases adhesion. Hence, compounds that can hydrate the insect debris, dissolve the protein content, and emulsify contained fats and oils form the basis of cleaning formulations in the present invention. Consequently, there are a number of chemical compounds and mixtures that can be used in the present invention and are within the scope of this disclosure. Among them are methyl alcohol, petroleum distillates, ethylene glycol mono butyl ether, other degreasers, fatty acids, glycerides, Mr. Clean Magic Eraser, WD-40, and Avon Skin-So-Soft. Additionally, it has been found that dampened laundry dryer sheets are exceedingly efficient at removing dried insect debris from automobiles without the need for scrubbing. Formulations for dispensing cleaner as a windshield wiper fluid and for impregnation into cleaning papers or cloths are disclosed herein. The latter formulations for paper or cloth can be dispensed by means of disposable windshield wiper appliances and cleaning tools of various forms as discussed below.

In addition to efficiency of insect debris removal, other important properties of a useful chemistry for this application include ease of formulation, absence of human and animal toxicity, biodegradability, ease of use, and economical implementation. Commercial laundry softeners and hair softeners and conditioners contain compounds that are ideal candidates for cleaning formulations in the present invention and exhibit many if not all of these properties.

Specifically, the fabric conditioning agents within dryer sheets that are transferred to laundry to impart fabric softening or other conditioning features exhibit surfactant properties useful in the present invention. For the purposes of the present invention, other chemicals found in dryer sheets that have been identified as potential carcinogens, hazardous pollutants, or endocrine disruptors are unnecessary. Among the typical softening agents found in dryer sheets are quaternary ammonium compounds (quats), glycerides, and fatty acids. Detail concerning compounds impregnated in dryer sheers is disclosed in U.S. Pat. No. 7,943,566 to Uitenbroek et al. and U.S. Pat. No. 5,080,810A to Smith et al, which disclose methods of manufacturing dryer sheets and are incorporated herein by reference thereto. Among such agents including surfactants found in dryer sheets, are silicone oils or tallow or vegetable-based quaternary ammonium compounds, these include alkylated quaternary ammonium compounds, ring or cyclic quaternary ammonium compounds, aromatic quaternary ammonium compounds, diquaternary ammonium compounds, amidoamine quaternary ammonium compounds, ester quaternary ammonium compounds, and mixtures of these.

Specific examples of these candidate compounds include monoesterquats, diesterquats, triesterquats, and mixtures thereof. These monoesterquats and diesterquats are selected from the group consisting of bis-(2-hydroxypropyl)-dimethylammonium methylsulfate fatty acid ester and isomers of bis-(2-hydroxypropyl)-dimethylammonium methylsulfate fatty acid ester and/or mixtures thereof, 1,2-di(acyloxy)-3-trimethylammoniopropane chloride, N,N-bis(stearoyl-oxy-ethyl)-N,N-dimethyl ammonium chloride, N,N-bis(tallowoyl-oxy-ethyl) N,N-dimethyl ammonium chloride, N,N-bis(stearoyl-oxy-ethyl)-N-(2 hydroxyethyl)-N-methyl ammonium methylsulfate, N,N-bis-(stearoyl-2-hydroxypropyl)-N,N-dimethylammonium methylsulfate, N,N-bis-(tallowoyl-2-hydroxypropyl)-N,N-dimethylammonium methylsulfate, N,N-bis-(palmitoyl-2-hydroxypropyl)-N,N-dimethylammonium methylsulfate, N,N-bis-(stearoyl-2-hydroxypropyl)-N,N-dimethylammonium chloride, 1,2-di-(stearoyl-oxy)-3-trimethyl ammoniumpropane chloride, dicanoladimethylammonium chloride, di(hard)tallowdimethylammonium chloride, dicanoladimethylammonium methylsulfate, 1-methyl-1-stearoylamidoethyl-2-stearoylimidazolinium methylsulfate, 1-tallowylamidoethyl-2-tallowylimidazoline, dipalmylmethyl hydroxyethylammoinum methylsulfate and mixtures thereof.

The categories of surfactants delineated in UK patent application number GB2185752A are hereby incorporated by reference thereto. These and other compounds that can promote efficient removal of insect and other debris from windshields are within the scope of the present invention.

Quats comprise some of the most potent surfactants that will lift and emulsify oil and fat residues of dessicated insects on vehicle glass, chromed bumpers, and painted bodies. A good survey of quat chemistry is provided by Bures (F. Bures, “Quaternary Ammonium Compounds: Simple in Structure, Complex in Application,” Topics in Current Chemistry (2019) 377:14). Many insects have a chitin- and protein-rich exoskeleton, and they are filled with an acidic liquid called hemolymph that is rich in digestive enzymes. This combination makes dead insects stick extremely well to vehicle surfaces. Hence, attention should be paid to controlling cleaner pH levels to augment debris removal without harming vehicle finishes. Quats such as benzalkonium chloride, used as medical disinfectants because they can denature cell proteins, can facilitate removal of proteinaceous insect debris. Examples of biodegradable quats include: a mixture of octyl decyl dimethyl ammonium chloride, dodecyl dimethyl ammonium chloride, and dioctyl dimethyl ammonium chloride, alkyl (C₁₄, 50%; C₁₂,40%; C₁₆, 10%) dimethyl benzyl ammonium chloride, as well as the compounds disclosed in European Patent Number EP0239910A2. Additionally, efforts have been underway for some time to design environmentally friendly quats (T. Thorsteinsson et al, “Soft Antimicrobial Agents: Synthesis and Activity of Labile Environmentally Friendly Long Chain Quaternary Ammonium Compounds,” J. Med. Chem. 2003, 46, 19, pp. 4173-4181.) that exhibit potential for cleaning effectiveness in the present invention.

Cationic surfactants are the magic behind hair conditioners because they latch strongly onto the negative charges on damaged hair. The right conditioners also attract moisture to eliminate static. These properties can be used to “condition” the insect debris for its removal from hard surfaces. In the hair care industry, considerable progress has been made in creating cationic polymers from natural substances, to facilitate biodegradability. The introduction of longer chain alkylquat groups onto the polymer substrate produces a family of products having distinct physical and conditioning properties. Here, the effect of a cationic substrate is combined with functional properties normally associated with fatty acid quats like hair manageability, lubricity, anti-static properties, surface activity and biocidal activity (H. Feigenbaum et al., “The Use of Cationizing Reagents in the Preparation of Conditioning Polymers for Hair and Skin Care,” SKW QUAB Chemicals, Incorporated, Saddle Brook, New Jersey.) Among the class of cationic polymers are polyquaternium compounds that are used in vast quantities in hair conditioners. These compounds can penetrate hard-to-access interfaces on automobile surfaces and will attract water to do the one thing most required to facilitate insect removal which is rehydration of the insect debris. Insects' cells are surrounded by negatively charged lipids so again the polyquaternium compounds can attach to them—with the rest of the cationic chain attracting water.

With the presence of the water, the cationic compound will dissolve the cell walls and the water soluble interior will also swell. The behavior of many polyquaternium compounds is insensitive to solution pH and water hardness which is conducive to their use in the present application. An example of a biodegradable compound of this type is the polyquaternium dermofeel® quadegra produced by Dr. Straetmans GmbH, Hamburg, Germany.

Cleaning formulations comprising aqueous- or alcohol-based solutions of surfactants or other active ingredients will typically involve concentrations of only a few volume percent of these ingredients.

Embodiments

Various embodiments of the present invention are herein disclosed that exploit chemistries useful for insect debris removal from windshields, bumpers and vehicle bodies. The taxonomy of embodiments comprises a) chemically-impregnated material removably attachable to wiper blades or blade assemblies, b) a roller dispenser of chemically-impregnated material, c) a combination of squeegee and roller dispenser of chemically-impregnated material, d) a pad dispenser of chemically-impregnated material, e) squeegee and pad dispenser combination, e) wipes of chemically-impregnated material, f) mitts with attached pads that are chemically-impregnated.

With respect to variants of the invention embodiment for wipers, all are a form of chemically-impregnated material removably attachable to windshield wiper blades or blade assemblies. The wide variety of feasible shapes for the removably attachable device are within the scope of the presently disclosed concept. Accommodation must be made for the variation in wiper blade sizes from vehicle to vehicle and, as described below, for embodiments that work with dynamic changes in wiper blade assembly geometry. These embodiments emphasize avoidance of hand contact with dirt, ease of application, and ease of disposal. The material to be chemically-impregnated is preferably microporous in nature. The most potent cleaning force is physical abrasion due to the no slip boundary condition (the cleaning fluid has zero velocity at the surface) between the insect debris and the automobile surface. Hence, this explains the improved cleaning performance of microfiber cloths which have far more surface contact than normal cloths and thereby translate more applied force into actual cleaning force.

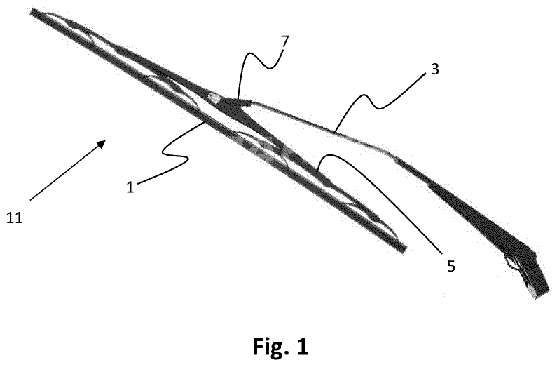

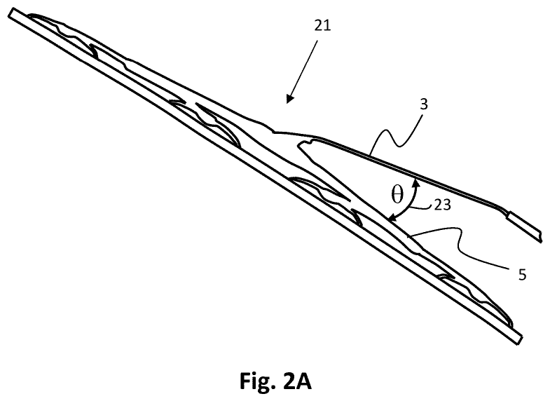

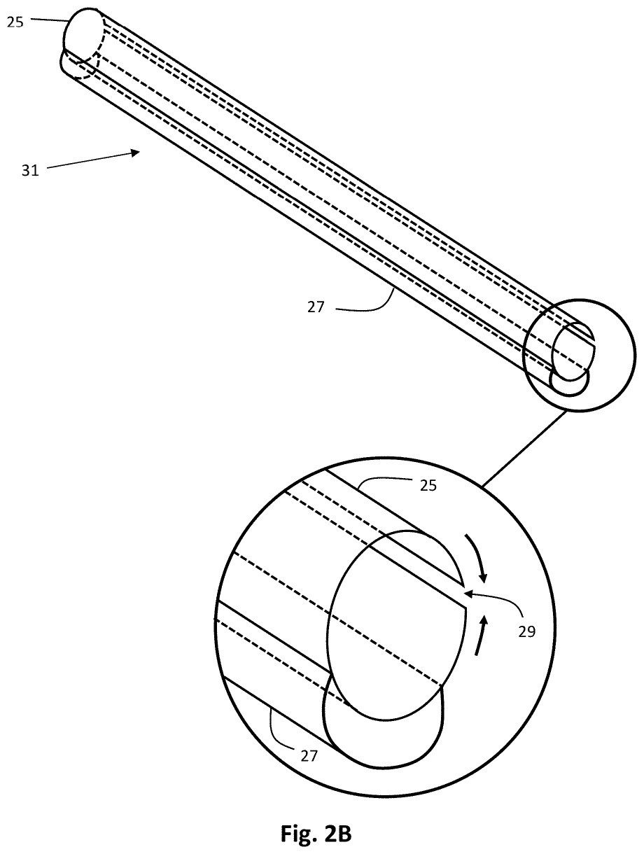

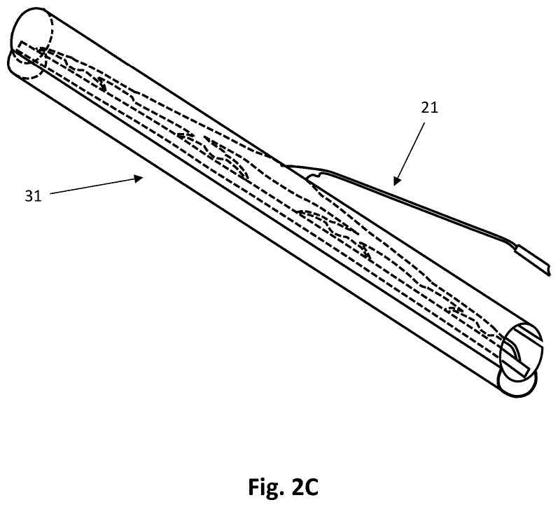

Reference is made to FIG. 1 which depicts the basic geometry 11 of the typical automobile windshield wiper system. The wiper blade 1 is held by the wiper blade assembly 5 that is mounted to the wiper arm 3 by articulating connection 7. FIG. 2A emphasizes the variation in angle 23 that can occur between the arm 3 and the wiper assembly 5 during wiper motion. For selected embodiments of the presently disclosed concept, angle variation must be accommodated. FIG. 2B depicts a first embodiment of a windshield cleaning attachment 31 comprising a stiff, but not rigid, cylinder 25 that exhibits a longitudinal slot 29. The cylinder 25 is constructed from a plastic or other material that demonstrates adequate closure tension for mounting on the wiper blade assembly. The slot edges of the cylinder are spread apart for installation on the wiper blade assembly. Attached to the stiff cylinder 25 is a pliable chemical containing pad 27 that is located at a circumferential position along the length of the cylinder that permits it to make contact with the windshield after it is installed on the wiper blade assembly as shown in FIG. 2C. Various cleaning chemicals previously discussed are candidates for impregnation of the pad 27. The cylinder 25 can be made of plastic, laminated card stock, or other semi rigid material that can be made to provide closure tension. The pad 27 can be made from natural or synthetic fabric, foam, or other porous material with volume enough to contain adequate cleaning chemical.

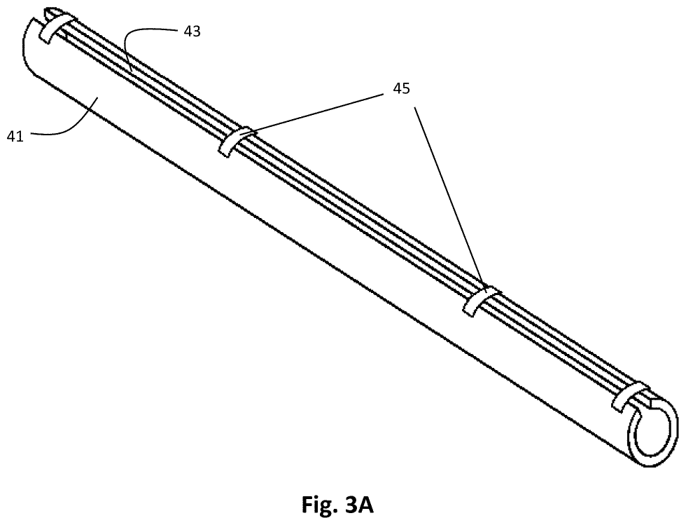

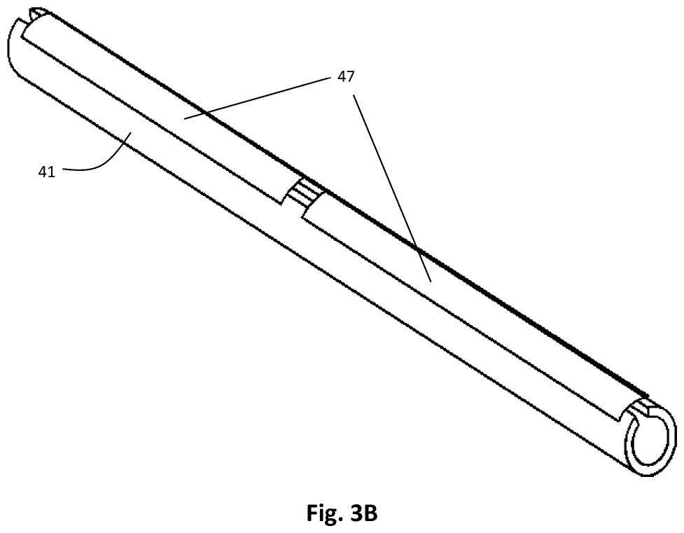

FIG. 3A depicts a cleaning chemical impregnated pad 41 that when mounted on the wiper blade assembly encloses it and demonstrates closure tabs 45 across the opening 43 created by the pad edges. The tabs can be Velcro™ or adhesive-based fasteners. In FIG. 38, closure strips 47 are shown substituted for tabs. Alternatively, the pad need not enclose the wiper blade assembly, but simply attach to the region of the blade that makes windshield contact.

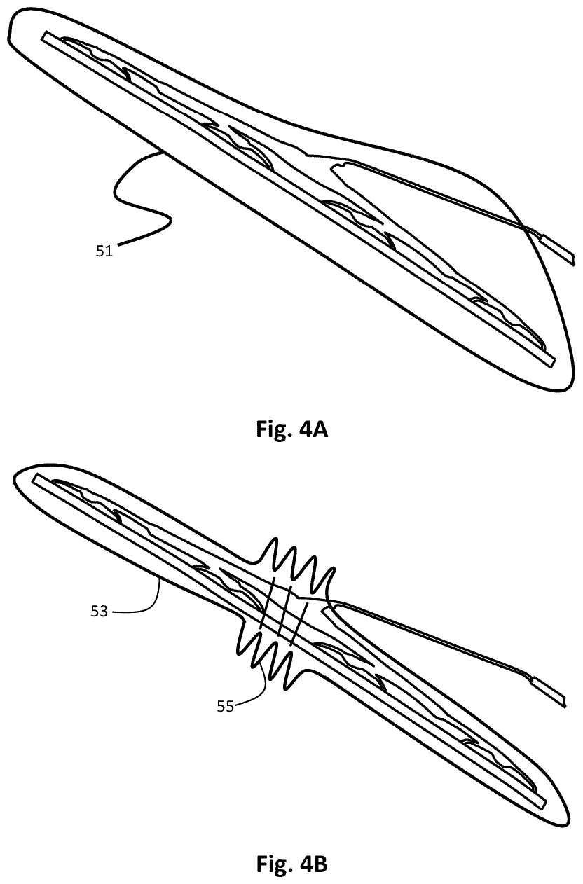

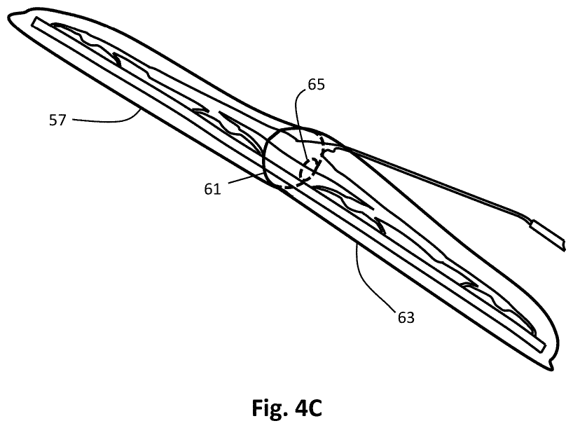

Bag geometries of the invention are shown in FIGS. 4A, B, and C. FIG. 4A depicts a bag or sleeve that encloses both wiper blade assembly and arm and accommodates the change in angle between the wiper blade assembly and the arm. The bag or sleeve is impregnated with cleaning chemical and may contain a pouch volume, not shown, for sufficient dispensing of chemical. FIG. 4B depicts a bag geometry that has a pleated region 53 to accommodate wiper changes in geometry during motion. The bag can have a closure mechanism, not shown, such as a draw string, Velcro™ strip, or elastic closure. Alternatively, the bag itself can exhibit elasticity sufficient to remain affixed to the wiper assembly during wiper motion. Yet another prospect is for the bag or sleeve to be slide onto the wiper assembly and have a tear away feature for ease of removal. A dual bag geometry is shown in FIG. 4C. A first bag 57 is used to cover a portion of the wiper blade assembly and had a cinched closure 65 at one end. A second bag 63 encloses the balance of the wiper blade assembly, overlaps the first bag 57 and has a cinched closure 61 atop the first bag. Bags 57 and 61 both have a chemical dispensing volume, not shown, in contact with the windshield.

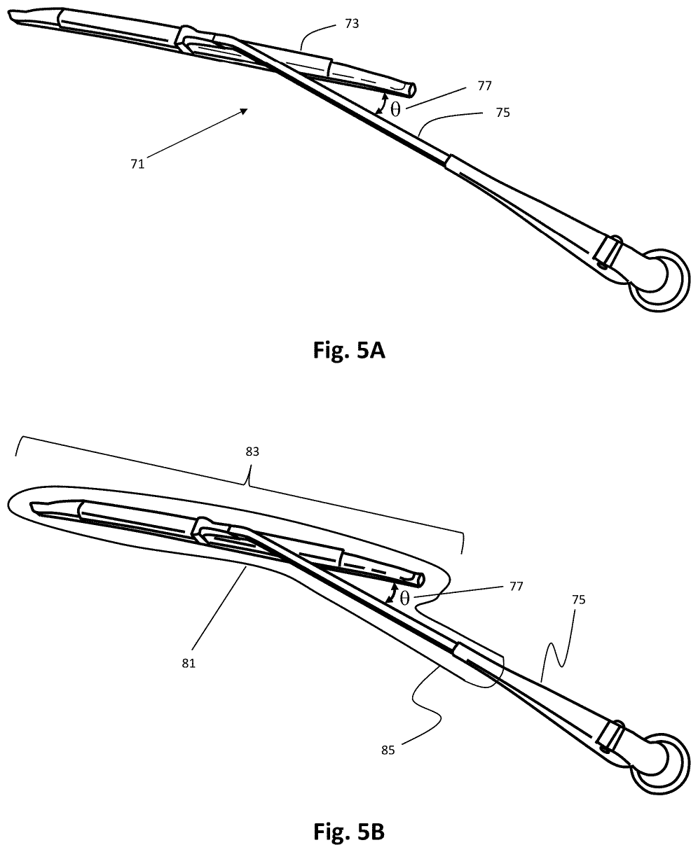

FIG. 5A depicts a wiper geometry 71 often found on trucks and other vehicles in which the angle 77 is relatively constant during wiper motion. In FIG. 5B, the bag 81 used in this instance encloses the region 83 of the wiper and region 85 of the wiper arm.

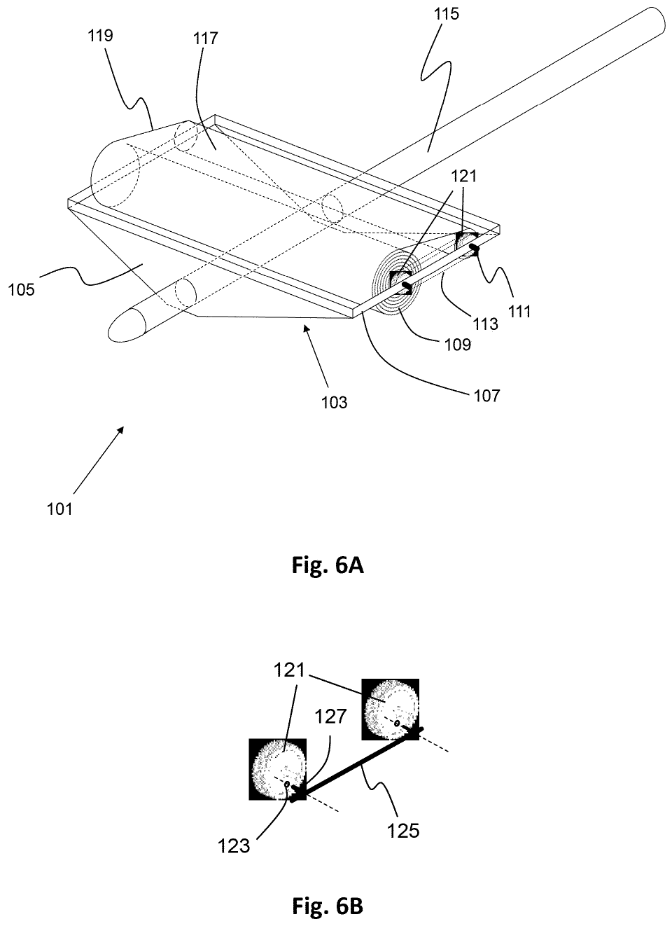

A cleaning appliance 101 exhibiting a roller dispenser 103 is depicted in FIG. 6A. Dispensing roller 109 feeds impregnated fabric (cloth, paper, etc.) to take-up roller 117. The area of the impregnated material that contacts a surface to be cleaned is maintained in tension by means of the gears 121 attached to the respective rollers 109 and 117 that are synchronized by roller belt 113. The axles 111 of the rollers are captivated in the frame 107 which is attached to the handle 115 by means of plates 105. The combination of the dispenser roller 109 and take-up roller 117 can be provided as a cartridge type consumer item wherein the rollers are in fixed relative disposition for sliding onto roller axles of the appliance 101, not shown.

FIG. 68 depicts a locking mechanism actuated by push button means, well known in the prior art and not shown. A bar 125 connects two locking pins 127 that are removably insertable into respective receptacles 123 in each of the gears 121. The pins 127 would be inserted to maintain the impregnated material stationary in the appliance 101 during surface cleaning.

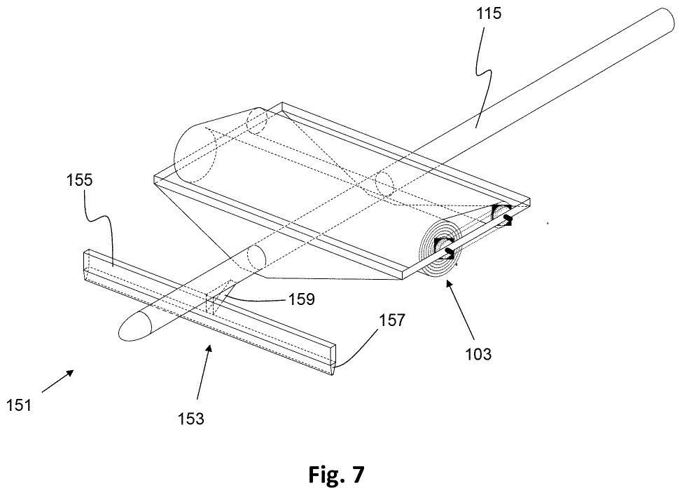

A squeegee assembly 153 is shown as an additional feature of the appliance 151 of FIG. 7. The squeegee assembly comprising a flexible surface contact 157 and the support structure 155 is attached to the underside of the handle 115 by bracket 159. With this geometry, the appliance can be rotated for use of either the roller dispenser or the squeegee.

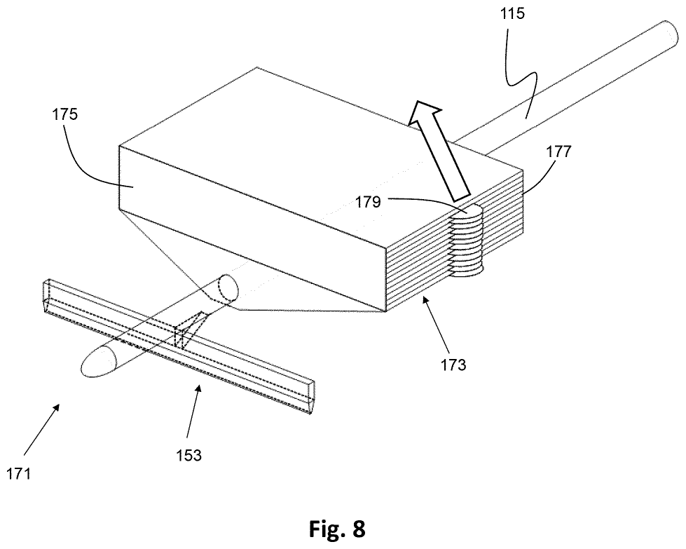

A container 175 of removable wipes 177 is depicted in FIG. 8. The wipes 177 can have a water impermeable backing and are adhered around their perimeters to adjacent wipes by a waterproof adhesive barrier that permits peeling removal of each wipe layer after use. A tab 179 attached to each layer of wipe can be grasped for manual peeling removal and disposal of a wipe after use.

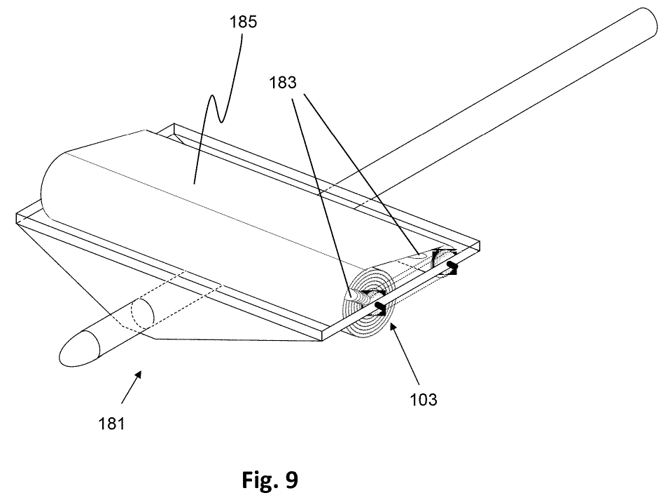

FIG. 9 depicts a roller dispenser 103 but with tear-off wipes 185 after the fashion of FIG. 8. The individual wipes 185 are dispensed from a backer sheet by manually pulling tabs 183.

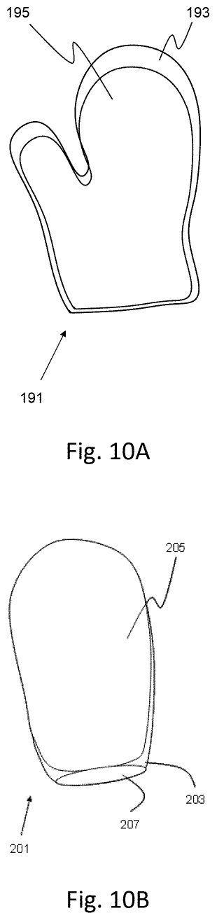

FIG. 10A shows a cleaning mitt that can be either disposable or have a replaceable chemically-impregnated pad. If disposable, the mitt has impregnated material 195 bonded to the mitt glove 193. In the case of reusable mitt glove, a Velcro attachable pad 195 is present. A less formed mitt is shown in FIG. 10B exhibiting a cleaning surface 205 on the body 203 of the mitt 201 having a hand opening 207.

Cleaning wipes can be made from various porous materials, synthetic or natural, that are impregnated with the cleaning composition for insect and debris removal. As mentioned previously, materials such as microfiber fabrics that offer larger surface area contact with the debris-laden surface are preferable.

Cleaning wipes and windshield wiper appliance formulation

The chief difference between a cleaning formulation for wipes (paper or cloth) and a wiper fluid formulation concerns the amount of incorporated solvent or carrier liquid. Since the use of wipes, wiper porous fiber-based appliances, and pad dispensers can be augmented with a water wash, this formulation will likely exhibit a higher concentration of active ingredients than the wiper fluid version. The same types of active ingredients can be used in both formulations. Preferred compounds would include surfactants (ex. quats) and surfactant polymers (ex. polyquats). Solvents would preferably comprise water and/or alcohols. Other candidate ingredients well known in the prior art comprise stabilizing agents, pH buffers, and modifiers of surface tension, interfacial tension and wetting, emulsifying, foaming, and suspension characteristics (Biswas et al., “Influence of additives on the properties of surfactant solutions”, Journal of Applied Chemistry, Volume 10, Issue 2 p. 73-80).

Windshield wiper fluid formulation

The aforementioned chemicals for insect debris removal can be active ingredients in a wiper fluid that would be dispensed in the same way as conventional windshield wiper fluid. So water soluble and solubilized surfactants are at the head of the list of candidate active ingredients in a windshield wiper formulation. In addition to surfactants, a general prescription for such a cleaner formulation also would comprise a hydrotrope, a builder, and a carrier. Builders are added to upgrade and protect the cleaning efficiency of surfactants. More specifically, builders can act as a buffer, an emulsifier, and to peptize dirt. Hydrotropes keep otherwise incompatible surfactants and builders stable in solution. Finally, the carrier is either water or a solvent.

As mentioned above, polyquaterniums also are viable candidates for few percent concentration solutions useful for insect debris removal. Among these candidate compounds, attention is directed to low toxicity variants that are biodegradable. Wiper fluid formulations that are tailored to insect debris removal can favor aqueous solutions of these compounds. The alternative is to combine these compounds in solutions with conventional windshield wiper fluid. Various cationic surfactants are compatible in solution with methanol, a chief constituent of windshield wiper fluid. Relative concentration of the given surfactant can be adjusted to achieve the requisite debris wetting behavior. In recent years, ester quats have been found advantageous in many commercial and industrial applications due to their biodegradable nature. However, the formulation of esterquat fabric softeners in aqueous based liquid formulations have been challenging because the ester linkages contained in the compound are susceptible to hydrolysis leading to shelf-life instability. Additionally, esterquats function over a narrow pH range. Other quats and quat derivatives have been engineered to overcome these limitations.

Various other embodiments of the disclosed concept not delineated, but which derive from this disclosure are deemed within the scope of the present invention.

1. A disposable wiper blade attachment for removal of difficult-to-remove windshield-adhered debris, the attachment comprising:
a. a chemically-impregnated windshield contacting element, and
b. windshield wiper attachment means,
the chemically-impregnated windshield contacting element comprising a fabric or foam impregnated with compounds that can remove windshield debris such as desiccated insects, the chemically-impregnated windshield contacting element attachable to a windshield wiper blade assembly.

2. A disposable wiper blade attachment as recited in claim 1, wherein the composition for the chemical impregnation is taken from the group comprising:
a) surfactants,
b) fatty acids, and
c) glycerides.

3. A disposable wiper blade attachment as recited in claim 2, wherein surfactants are taken from the group comprising:
a) Amphiphiles
b) Cationic surfactants
c) Anionic surfactants
d) Nonionic surfactants . . .
e) Amphoteric Surfactants
f) Silicon Surfactants
g) Fluorinated Surfactants
h) Polymeric Surfactants or Surfactant Polymers
i) Association Polymers

4. A disposable wiper blade attachment as recited in claim 2, wherein surfactants are taken from the group comprising:
a) vegetable-based quaternary ammonium compounds,
b) alkylated quaternary ammonium compounds,
c) ring or cyclic quaternary ammonium compounds,
d) aromatic quaternary ammonium compounds,
e) diquaternary ammonium compounds,
f) amidoamine quaternary ammonium compounds,
g) ester quaternary ammonium compounds, and
h) polyquaterniums.

5. A disposable wiper blade attachment as recited in claim 1, wherein the composition for the chemical impregnation is taken from the additional group comprising:
a) silicone oils,
b) tallow,
c) polydimethylsiloxane,
d) methyl alcohol,
e) petroleum distillates,
f) ethylene glycol mono butyl ether,
g) other degreasers,
h) Mr. Clean Magic Eraser,
i) WD-40, and
j) Avon Skin-So-Soft.

6. A disposable wiper blade attachment as recited in claim 1 for attachment to a wiper assembly, wherein the windshield wiper attachment means comprises a flexible cylinder exhibiting a length and diameter and with a slit along its length, the cylinder exhibiting closure tension as it captivates the wiper assembly, the chemically-impregnated windshield contacting element comprises a linear foam or cloth pad affixed along the length of the flexible cylinder so as to conformally contact the windshield when the wiper blade attachment is installed on the wiper assembly.

7. A disposable wiper blade attachment as recited in claim 1 for attachment to a wiper assembly, wherein the chemically-impregnated windshield contacting element comprises a linear foam or cloth sheet and the attachment means comprises adhesive or Velcro™ straps, the cloth or foam sheet rolled around the wiper assembly and affixed to it by the attachment means.

8. A disposable wiper blade attachment as recited in claim 1 for attachment to a wiper assembly, wherein the chemically-impregnated windshield contacting element comprises a linear foam or cloth pad and the attachment means comprises adhesive or Velcro™ straps, the cloth or foam pad affixed to the wiper assembly so as to contact a windshield.

9. A disposable wiper blade attachment as recited in claim 1 an elongated bag of cloth or foam material which is chemically-impregnated and attaches to the wiper assembly by enveloping the wiper assembly and exhibits a closure mechanism.

10. A disposable wiper blade attachment as recited in claim 5 wherein the elongated bag is form-fitted to the wiper assembly and exhibits flexure bellows to accommodate wiper motion.

11. A disposable wiper blade attachment as recited in claim 5 wherein the elongated bag is comprises two halves that are affixed together at the longitudinal center of the wiper assembly.

12. A disposable wiper blade attachment as recited in claim 1 for attachment to a wiper assembly and wiper arm, comprising a chemically-impregnated enclosure that encloses the wiper assembly and a portion of the wiper arm.

13. A windshield washer solution comprising compounds taken from the group comprising:
a) vegetable-based quaternary ammonium compounds,
b) alkylated quaternary ammonium compounds,
c) ring or cyclic quaternary ammonium compounds,
d) aromatic quaternary ammonium compounds,
e) diquaternary ammonium compounds,
f) amidoamine quaternary ammonium compounds, and
g) ester quaternary ammonium compounds.

14. A windshield washer solution as recited in claim 11 comprising additional compounds taken from the group comprising:
a) surfactants found in dryer sheets,
b) silicone oils or tallow or vegetable-based quaternary ammonium compounds,
c) polydimethylsiloxane,
d) alkylated quaternary ammonium compounds,
e) ring or cyclic quaternary ammonium compounds,
f) aromatic quaternary ammonium compounds,
g) diquaternary ammonium compounds,
h) amidoamine quaternary ammonium compounds,
i) ester quaternary ammonium compounds, and
j) methyl alcohol,
k) petroleum distillates,
l) ethylene glycol mono butyl ether, other degreasers,
m) Mr. Clean Magic Eraser,
n) WD-40,and
o) Avon Skin-So-Soft.

15. A vehicle cleaning tool comprising:
a) a handle and
b) a dispenser of disposable surfactant-containing porous material attached thereto.

16. A vehicle cleaning tool as recited in claim 15, wherein, the dispenser further comprises:
a) a dispensing roller capable of dispensing impregnated material from a roll of impregnated material and
b) a take up roller capable of rolling take up of expended impregnated material, the dispensing roller and the take up roller having provision for maintaining tension of a region of the impregnated material making contact with a surface to be cleaned.

17. A vehicle cleaning tool as recited in claim 16, wherein, the dispensed impregnated material is removably adhered to a water and alcohol impervious backing material and is capable of peelable removal from the backing material.

18. A vehicle cleaning tool as recited in claim 15, wherein, the dispenser further comprises:
a container of removable impregnated pads.

19. A vehicle cleaning tool as recited in claim 15, which includes a squeegee attached to the handle.
